(19) United States
(12) Patent Application Publication
(10) Pub. No.: US 2025/0232084 A1
(43) Pub. Date: Jul. 17, 2025

(54) EFFICIENT METHOD FOR SOLVING ELECTROMAGNETIC FIELD OF RADIATION SOURCE LAYER IN LAYERED LOSSY MEDIUM

(71) Applicant: NORTHWESTERN POLYTECHNICAL UNIVERSITY, Xi 'an (CN)

(72) Inventors: Honglei WANG, Xi 'an (CN); Yulong WEI, Xi 'an (CN); Yingda REN, Xi 'an (CN)

(73) Assignee: NORTHWESTERN POLYTECHNICAL UNIVERSITY, Xi 'an (CN)

(21) Appl. No.: 19/012,820

(22) Filed: Jan. 7, 2025

(30) Foreign Application Priority Data
Jan. 13, 2024 (CN) 202410049889.6

(51) Int. Cl. G06F 30/20; G01V 20/00

(52) U.S. Cl. CPC G06F 30/20; G01V 20/00

(57) ABSTRACT

In an efficient method for solving the electromagnetic field of the radiation source layer in the layered lossy medium, the secondary field is obtained by selecting the amplitude coefficient from the interface of the radiation source layer, and then superimposed with the background field to obtain the electromagnetic field of the radiation source layer. Due to the minimum difference in the amplitude coefficient from the interface of the radiation source layer, this method has lower requirements on the integration interval and the number of sampling points, and the background field can be directly obtained by the theoretical formula. The method significantly reduces overall memory usage and computation time, thereby improving computational efficiency. The method lowers the computational cost of solving the electromagnetic field of the radiation source layer in a layered lossy medium, enhances the model's solution efficiency, and supports the effective development of marine electromagnetic detection and related research.

### CROSS REFERENCE TO THE RELATED APPLICATIONS

This application is based upon and claims priority to Chinese Patent Application No. 202410049889.6, filed on Jan. 13, 2024, the entire contents of which are incorporated herein by reference.

### TECHNICAL FIELD

The invention belongs to electromagnetic field modeling and simulation and relates to an efficient method for solving an electromagnetic field of a radiation source layer in a layered lossy medium.

### BACKGROUND

The layered lossy medium model is widely used in marine electromagnetic detection, magnetotelluric forward modeling, and underwater electromagnetic wave propagation characteristics due to its simple structure and clear physical characteristics. In these studies, the transceiver devices are mostly located in the same horizontal layer. Therefore, in order to ensure its smooth development, it is necessary to realize the efficient and accurate solution of the electromagnetic field in the radiation source layer of the layered lossy medium model.

At present, the methods for solving the electromagnetic field in the layered lossy medium model are mainly divided into three categories: analytical approximation methods, semi-analytical methods, and numerical methods. Among them, the analytical approximation method obtains the approximate analytical solution under certain conditions by approximating the Sommerfeld integral equation, the method is fast but limited by the approximate conditions. The numerical method refers to the finite difference method or the finite element method, which meshes the electromagnetic parameters in the model and solves the electromagnetic field based on the Maxwell equation, this method can solve the electromagnetic wave in a complex environment, but it is computationally expensive. The semi-analytical method is used to numerically solve the Sommerfeld integral equation in the analytical solution. This method maintains both accuracy and generality while requiring relatively lower computational resources, making it widely used.

However, unlike in the lossless medium, the electromagnetic waves experience absorption loss in the lossy medium, resulting in a significant amplitude difference between the upward and downward propagating waves in the radiation source layer. The singularity of the radiation source further accentuates the amplitude difference within the radiation source layer. To ensure the accuracy of the solution results, it is necessary to expand the Sommerfeld integral interval and increase the number of sampling points, which will greatly increase the cost of solving the electromagnetic field of the radiation source layer. Therefore, it is necessary to propose a method to reduce the cost of the solution and improve its efficiency.

In order to reduce the computational cost of the electromagnetic field of the radiation source layer in the layered lossy medium, improve the solution speed while ensuring the accuracy of the results, and ensure the efficient development of marine electromagnetic detection and other research, the method in the invention is proposed.

Due to the significant differences in the amplitude coefficients of the received electromagnetic field of the radiation source layer in the layered lossy medium, the difficulty and computational cost of traditional methods are greatly increased.

### SUMMARY

### Technical Problems to be Solved

To address the limitations of existing techniques for calculating the electromagnetic field of the radiation source layer in layered lossy media, this invention proposes an efficient solving method aimed at reducing the computational cost and improving the solution efficiency. The proposed method ensures the efficient development of marine electromagnetic detection and other research. Compared to traditional approaches, this method demonstrates superior performance by significantly reducing computational time and resource requirements.

The main contents of the invention are as follows:
1) Based on the layered lossy medium model, the amplitude coefficients of the electromagnetic field in the radiation source layer are solved. In this method, the amplitude coefficients from the radiation source are disregarded, while the amplitude coefficients of the upper and lower interfaces are retained. These retained coefficients are substituted into the electromagnetic field equations. Subsequently, the Sommerfeld integral in these equations is solved by direct integration or the fast Fourier method. The electromagnetic field obtained by the solution is the secondary field composed of the lateral waves and the reflected waves. Due to the minimum difference between the amplitude coefficients selected, it is unnecessary to increase the integration range or the number of sampling points, thereby reducing the computational resource requirements and improving overall efficiency.
2) The background electromagnetic field generated by the radiation source can be determined based on the theoretical formulas for calculating field strength in free space, combined with the electromagnetic parameters of the radiation source layer.
3) The electromagnetic field of the radiation source layer in the layered lossy medium is obtained by adding the calculation results of the secondary field and the background field in 1) and 2).

### Technical Solution

An efficient method for solving an electromagnetic field of a radiation source layer in a layered lossy medium is characterized by the following steps:
Step 1: expressing an electromagnetic field of a radiation source layer in a layered lossy medium model as a superposition of Transverse Electric (TE) wave and Transverse Magnetic (TM) wave, and establishing an electromagnetic field expression of each electromagnetic field component;
Step 2: according to boundary conditions of the electromagnetic field, a propagation matrix, and a dipole antenna type, obtaining amplitude coefficients of the radiation source layer when z≥0:

$$\{ \begin{matrix}{A}_{0 +} = \frac{[ {ε}_{0}^{*} {ξ}_{- 1} + {ε}_{- 1}^{*} {ξ}_{0} + ( {ε}_{- 1}^{*} {ξ}_{0} - {ε}_{0}^{*} {ξ}_{- 1} ) {e}^{j 2 {ξ}_{0} {d}_{0}} ] {E}_{hmd}}{{ε}_{0}^{*} {ξ}_{- 1} + {ε}_{- 1}^{*} {ξ}_{0} - \frac{( {ε}_{1}^{*} {ξ}_{0} - {ε}_{0}^{*} {ξ}_{1} ) ( {ε}_{- 1}^{*} {ξ}_{0} - {ε}_{0}^{*} {ξ}_{- 1} )}{{ε}_{1}^{*} {ξ}_{0} + {ε}_{0}^{*} {ξ}_{1}} {e}^{j 2 {ξ}_{0} ( {d}_{1} - {d}_{0} )}} \\ {B}_{0 +} = {A}_{0 +} ( \frac{{ε}_{1}^{*} {ξ}_{0} - {ε}_{0}^{*} {ξ}_{1}}{{ε}_{1}^{*} {ξ}_{0} + {ε}_{0}^{*} {ξ}_{1}} ) {e}^{j 2 {ξ}_{0} {d}_{1}} \\ {C}_{0 +} = \frac{[ {μ}_{0} {ξ}_{- 1} + {μ}_{- 1} {ξ}_{0} - ( {μ}_{- 1} {ξ}_{0} - {μ}_{0} {ξ}_{- 1} ) {e}^{- j 2 {ξ}_{0} {d}_{0}} ] {H}_{hmd}}{{μ}_{0} {ξ}_{- 1} + {μ}_{- 1} {ξ}_{0} - \frac{( {μ}_{1} {ξ}_{0} - {μ}_{0} {ξ}_{1} ) ( {μ}_{- 1} {ξ}_{0} - {μ}_{0} {ξ}_{- 1} )}{{μ}_{1} {ξ}_{0} + {μ}_{0} {ξ}_{1}} {e}^{j 2 {ξ}_{0} ( {d}_{1} - {d}_{0} )}} \\ {D}_{0 +} = {C}_{0 +} ( \frac{{μ}_{1} {ξ}_{0} - {μ}_{0} {ξ}_{1}}{{μ}_{1} {ξ}_{0} + {μ}_{0} {ξ}_{1}} ) {e}^{j 2 {ξ}_{0} {d}_{1}}\end{matrix}$$

in the formula, A₀₊, B₀₊, C₀₊ and D₀₊ denote amplitude coefficients of the radiation source layer when z≥0, ξₗ=(kₗ²−k^{ρ2}), kₗ is the propagation constant, εₗ* is the complex dielectric constant and μₗ is the permeability in the l-th layer, E_{hmd}=ISωμ₀k_{ρ}²/8πξ₀ and H_{hmd}=−ISk_{ρ}²/8π, IS is a magnetic dipole moment;
the amplitude coefficients of the radiation source layer when z≤0:

$$\{ \begin{matrix}{A}_{0 -} = {A}_{0 +} - {E}_{hmd} \\ {B}_{0 -} = {B}_{0 +} + {E}_{hmd} \\ {C}_{0 -} = {C}_{0 +} - {H}_{hmd} \\ {D}_{0 -} = {D}_{0 +} - {H}_{hmd}\end{matrix}$$

Step 3: selecting A₀₊, B₀₋ and C₀₊, D₀₋ with smallest amplitude differences and substituting A₀₊, B₀₋ and C₀₊, D₀₋ with the smallest amplitude differences into the electromagnetic field expression to solve each electromagnetic field component, and obtaining a secondary field composed of the lateral waves and the reflected waves from the upper and lower interfaces of the radiation source layer;
Step 4: performing a vector sum of the secondary field and a background field to obtain each component of a total electromagnetic field in the radiation source layer.

A three-layer lossy medium model is taken as an example: A thickness of a 1^{st} layer to a −1^{st} layer is infinite; a 0^{th} layer is a layer where a radiation source is located, the thickness of the 0^{th} layer is d, a radiation antenna is a horizontal magnetic dipole (HMD), and a distance from the radiation antenna to an upper interface of the 0^{th} layer is d₁; an origin O of the cylindrical coordinate system is at the center of the radiation source; a receiving point P is located in a coordinate (ρ, φ, z); μₗ, εₗ, and σₗ are a permeability, a dielectric constant and a conductivity of the l-th layer (l=−1, 0, 1), respectively.

In Step 1, when a solved radiation source is the HMD, expressions for each electromagnetic field component in the radiation source layer are:

$${E}_{0 z} = {\int }_{- ∞}^{∞} {dk}_{ρ} ( {A}_{0} {e}^{i {ξ}_{0} z} + {B}_{0} {e}^{- i {ξ}_{0} z} ) {H}_{1}^{( 1 )} ( {k}_{ρ} ρ ) sin ( φ )$$

$${E}_{0 ρ} = {\int }_{- ∞}^{∞} {dk}_{ρ} \frac{i {ξ}_{0}}{{k}_{ρ}} ( {A}_{0} {e}^{i {ξ}_{0} z} - {B}_{0} {e}^{- i {ξ}_{0} z} ) {H}_{1}^{{( 1 )}^{′}} ( {k}_{ρ} ρ ) sin ( φ ) + {\int }_{- ∞}^{∞} {dk}_{ρ} \frac{- i ω {μ}_{0}}{{k}_{ρ}^{2} ρ} ( {C}_{0} {e}^{i {ξ}_{0} z} + {D}_{0} {e}^{- i {ξ}_{0} z} ) {H}_{1}^{( 1 )} ( {k}_{ρ} ρ ) sin ( φ )$$

$${E}_{0 φ} = {\int }_{- ∞}^{∞} {dk}_{ρ} \frac{i {ξ}_{0}}{{k}_{ρ}^{2} ρ} ( {A}_{0} {e}^{i {ξ}_{0} z} - {B}_{0} {e}^{- i {ξ}_{0} z} ) {H}_{1}^{( 1 )} ( {k}_{ρ} ρ ) cos ( φ ) + {\int }_{- ∞}^{∞} {dk}_{ρ} \frac{- i ω {μ}_{0}}{{k}_{ρ}} ( {C}_{0} {e}^{i {ξ}_{0} z} + {D}_{0} {e}^{- i {ξ}_{0} z} ) {H}_{1}^{{( 1 )}^{′}} ( {k}_{ρ} ρ ) cos ( φ )$$

$${H}_{0 z} = {\int }_{- ∞}^{∞} {dk}_{ρ} ( {C}_{0} {e}^{i {ξ}_{0} z} + {D}_{0} {e}^{- i {ξ}_{0} z} ) {H}_{1}^{( 1 )} ( {k}_{ρ} ρ ) cos ( φ )$$

$${H}_{0 ρ} = {\int }_{- ∞}^{∞} {dk}_{ρ} \frac{i {ξ}_{0}}{{k}_{ρ}} ( {C}_{0} {e}^{i {ξ}_{0} z} - {D}_{0} {e}^{- i {ξ}_{0} z} ) {H}_{1}^{{( 1 )}^{′}} ( {k}_{ρ} ρ ) cos ( φ ) + {\int }_{- ∞}^{∞} {dk}_{ρ} \frac{- i {ωε}_{0}^{*}}{{k}_{ρ}^{2} ρ} ( {A}_{0} {e}^{i {ξ}_{0} z} + {B}_{0} {e}^{- i {ξ}_{0} z} ) {H}_{1}^{( 1 )} ( {k}_{ρ} ρ ) cos ( φ )$$

$${H}_{0 φ} = {\int }_{- ∞}^{∞} {dk}_{ρ} \frac{- i {ξ}_{0}}{{k}_{ρ}^{2} ρ} ( {C}_{0} {e}^{i {ξ}_{0} z} - {D}_{0} {e}^{- i {ξ}_{0} z} ) {H}_{1}^{( 1 )} ( {k}_{ρ} ρ ) sin ( φ ) + {\int }_{- ∞}^{∞} {dk}_{ρ} \frac{- i {ωε}_{0}^{*}}{{k}_{ρ}} ( {A}_{0} {e}^{i {ξ}_{0} z} + {B}_{0} {e}^{- i {ξ}_{0} z} ) {H}_{1}^{{( 1 )}^{′}} ( {k}_{ρ} ρ ) sin ( φ )$$

in the formula, A₀, B₀, C₀, and Do are amplitude coefficients of TM and TE waves in the radiation source layer, respectively; H₁⁽¹⁾(k_{ρ}ρ) is the first order Hankel function of the first kind; H₁⁽¹⁾′(k_{ρ}ρ) denotes a derivative of H₁⁽¹⁾(η) for argument η; ξ₀ satisfies ξ₀=\sqrt{k₀²=k_{ρ}²}, a propagation constant k₀ in the radiation source layer is expressed as:

$${k}_{0} = \sqrt{i {ωμ}_{0} {σ}_{0} - {ω}^{2} {μ}_{0} {ε}_{0}} .$$

The secondary field in Step 3 is:

$${E}_{0 z}^{sec} = {\int }_{- ∞}^{∞} {dk}_{ρ} ( {A}_{0 +} {e}^{i {ξ}_{0} z} + {B}_{0 -} {e}^{- i {ξ}_{0} z} ) {H}_{1}^{( 1 )} ( {k}_{ρ} ρ ) sin ( φ )$$

$${E}_{0 ρ}^{sec} = {\int }_{- ∞}^{∞} {dk}_{ρ} \frac{i {ξ}_{0}}{{k}_{ρ}} ( {A}_{0 +} {e}^{i {ξ}_{0} z} - {B}_{0 -} {e}^{- i {ξ}_{0} z} ) {H}_{1}^{{( 1 )}^{′}} ( {k}_{ρ} ρ ) sin ( φ ) + {\int }_{- ∞}^{∞} {dk}_{ρ} \frac{- i ω {μ}_{0}}{{k}_{ρ}^{2} ρ} ( {C}_{0 +} {e}^{i {ξ}_{0} z} + {D}_{0 -} {e}^{- i {ξ}_{0} z} ) {H}_{1}^{( 1 )} ( {k}_{ρ} ρ ) sin ( φ )$$

$${E}_{0 φ}^{sec} = {\int }_{- ∞}^{∞} {dk}_{ρ} \frac{i {ξ}_{0}}{{k}_{ρ}^{2} ρ} ( {A}_{0 +} {e}^{i {ξ}_{0} z} - {B}_{0 -} {e}^{- i {ξ}_{0} z} ) {H}_{1}^{( 1 )} ( {k}_{ρ} ρ ) cos ( φ ) + {\int }_{- ∞}^{∞} {dk}_{ρ} \frac{- i ω {μ}_{0}}{{k}_{ρ}} ( {C}_{0 +} {e}^{i {ξ}_{0} z} - {D}_{0 -} {e}^{- i {ξ}_{0} z} ) {H}_{1}^{{( 1 )}^{′}} ( {k}_{ρ} ρ ) cos ( φ )$$

$${H}_{0 z}^{sec} = {\int }_{- ∞}^{∞} {dk}_{ρ} ( {C}_{0 +} {e}^{i {ξ}_{0} z} + {D}_{0 -} {e}^{- i {ξ}_{0} z} ) {H}_{1}^{( 1 )} ( {k}_{ρ} ρ ) cos ( φ )$$

$${H}_{0 ρ}^{sec} = {\int }_{- ∞}^{∞} {dk}_{ρ} \frac{i {ξ}_{0}}{{k}_{ρ}} ( {C}_{0 +} {e}^{i {ξ}_{0} z} - {D}_{0 -} {e}^{- i {ξ}_{0} z} ) {H}_{1}^{{( 1 )}^{′}} ( {k}_{ρ} ρ ) cos ( φ ) + {\int }_{- ∞}^{∞} {dk}_{ρ} \frac{- i ω {ε}_{0}^{*}}{{k}_{ρ}^{2} ρ} ( {A}_{0 +} {e}^{i {ξ}_{0} z} + {B}_{0 -} {e}^{- i {ξ}_{0} z} ) {H}_{1}^{( 1 )} ( {k}_{ρ} ρ ) cos ( φ )$$

$${H}_{0 φ}^{sec} = {\int }_{- ∞}^{∞} {dk}_{ρ} \frac{- i {ξ}_{0}}{{k}_{ρ}^{2} ρ} ( {C}_{0 +} {e}^{i {ξ}_{0} z} - {D}_{0 -} {e}^{- i {ξ}_{0} z} ) {H}_{1}^{( 1 )} ( {k}_{ρ} ρ ) sin ( φ ) + {\int }_{- ∞}^{∞} {dk}_{ρ} \frac{- i {ωε}_{0}^{*}}{{k}_{ρ}} ( {A}_{0 +} {e}^{i {ξ}_{0} z} + {B}_{0 -} {e}^{- i {ξ}_{0} z} ) {H}_{1}^{{( 1 )}^{′}} ( {k}_{ρ} ρ ) sin ( φ )$$

Each component of the total electromagnetic field in Step 4 is:

$${E}_{0 z} = {E}_{0 z}^{sec} + {E}_{0 z}^{bac} {H}_{0 z} = {H}_{0 z}^{sec} + {H}_{0 z}^{bac}$$

$${E}_{0 ρ} = {E}_{0 ρ}^{sec} + {E}_{0 ρ}^{bac} {H}_{0 ρ} = {H}_{0 ρ}^{sec} + {H}_{0 ρ}^{bac}$$

$${E}_{0 φ} = {E}_{0 φ}^{sec} + {E}_{0 φ}^{bac} {H}_{0 φ} = {H}_{0 φ}^{sec} + {H}_{0 φ}^{bac}$$

The background field is obtained directly from a theoretical formula:

$${E}_{0 z}^{bac} = \frac{i ω {μ}_{0} ρ IS sin ( φ )}{4 {π ( {ρ}^{2} + {z}^{2} )}^{3 / 2}} ( 1 + {ik}_{0} \sqrt{{ρ}^{2} + {z}^{2}} ) {e}^{- {ik}_{0} \sqrt{{ρ}^{2} + {z}^{2}}}$$

$${E}_{0 ρ}^{bac} = \frac{i {ωμ}_{0} ρ IS sin ( φ )}{4 {π ( {ρ}^{2} + {z}^{2} )}^{3 / 2}} ( - 1 - {ik}_{0} \sqrt{{ρ}^{2} + {z}^{2}} ) {e}^{- {ik}_{0} \sqrt{{ρ}^{2} + {z}^{2}}}$$

$${E}_{0 φ}^{bac} = \frac{i ω {μ}_{0} zIS cos ( φ )}{4 {π ( {ρ}^{2} + {z}^{2} )}^{3 / 2}} ( - 1 - {ik}_{0} \sqrt{{ρ}^{2} + {z}^{2}} ) {e}^{- {ik}_{0} \sqrt{{ρ}^{2} + {z}^{2}}}$$

$${H}_{0 z}^{bac} = \frac{ISz ρ cos ( φ )}{4 {π ( {ρ}^{2} + {z}^{2} )}^{5 / 2}} ( 3 + i 3 {k}_{0} \sqrt{{ρ}^{2} + {z}^{2}} - {k}_{0}^{2} ( {ρ}^{2} + {z}^{2} ) ) {e}^{- {ik}_{0} \sqrt{{ρ}^{2} + {z}^{2}}}$$

$${H}_{0 ρ}^{bac} = \frac{IS {ρ}^{2} cos ( φ )}{2 {π ( {ρ}^{2} + {z}^{2} )}^{5 / 2}} ( 1 + {ik}_{0} \sqrt{{ρ}^{2} + {z}^{2}} ) {e}^{- {ik}_{0} \sqrt{{ρ}^{2} + {z}^{2}}} - \frac{{ISz}^{2} cos ( φ )}{4 {π ( {ρ}^{2} + {z}^{2} )}^{5 / 2}} ( 1 + {ik}_{0} \sqrt{{ρ}^{2} + {z}^{2}} - {k}_{0}^{2} ( {ρ}^{2} + {z}^{2} ) ) {e}^{- {ik}_{0} \sqrt{{ρ}^{2} + {z}^{2}}}$$

$${H}_{0 φ}^{bac} = \frac{IS sin ( φ )}{4 {π ( {ρ}^{2} + {z}^{2} )}^{5 / 2}} ( 1 + {ik}_{0} \sqrt{{ρ}^{2} + {z}^{2}} - {k}_{0}^{2} ( {ρ}^{2} + {z}^{2} ) ) {e}^{- {ik}_{0} \sqrt{{ρ}^{2} + {z}^{2}}}$$

An application of the efficient method for solving the electromagnetic field of the radiation source layer in the layered lossy medium is characterized by selecting amplitude coefficients with the smallest amplitude difference to obtain the secondary field of the radiation source layer, and then obtaining the total electromagnetic field of the radiation source layer through vector superposition with the background field; it is used to support the efficient development of marine electromagnetic detection research.

### Beneficial Effects

The invention proposes an efficient method for solving the electromagnetic field of the radiation source layer in the layered lossy medium, addressing the issue of high computational cost and low solution efficiency associated with electromagnetic field calculations of the radiation source layer in the layered lossy medium. This method enables rapid and cost-effective determination of the electromagnetic field in the radiation source layer of the lossy medium, thereby facilitating the efficient advancement of marine electromagnetic detection and related research.

Innovations: In the lossy medium model, the amplitude coefficients of the electromagnetic field in the radiation source layer exhibit significant variation, requiring traditional methods to increase both the integration interval and the number of sampling points to maintain computational accuracy, which will significantly reduce the solution efficiency of the electromagnetic field of the radiation source layer. To address these limitations, the method proposed in this application introduces an innovative calculation process. Unlike the traditional method of selecting the amplitude coefficients according to the receiving position, this method directly selects the amplitude coefficients from the interface of the radiation source layer to calculate the secondary field, and then superimposes it with the background field to obtain the electromagnetic field of the radiation source layer. Due to the minimum difference in the amplitude coefficients from the interface of the radiation source layer, this method has lower requirements on the integration interval and the number of sampling points, and the background field can be directly obtained by the theoretical formula. Compared with the traditional method, this approach requires less memory and computational time, while maintaining or improving accuracy, thereby achieving markedly higher computational efficiency.

### BRIEF DESCRIPTION OF THE DRAWINGS

FIG. 1 is a schematic diagram of the three-layer lossy medium model; where the thickness of a 1^{st} layer to a −1^{st} layer is infinite; a 0^{th} layer is a layer where a radiation source is located, the thickness of the 0^{th} layer is d, a radiation antenna is a horizontal magnetic dipole (HMD), and a distance from the radiation antenna to an upper interface of the 0^{th} layer is d₁; an origin O of the cylindrical coordinate system is at the center of the radiation source; a receiving point P is located in a coordinate (ρ, φ, z); μₗ, εₗ, and σₗ are the permeability, the dielectric constant and the conductivity of the l-th layer (l=−1, 0, 1), respectively.

FIGS. 2A-2B show comparisons of the amplitude coefficients of the TM wave in the radiation source layer;

FIG. 2A is a real part, and FIG. 2B is an imaginary part. The curves in FIGS. 2A-2B show the variation of the amplitude coefficients of TM waves in the radiation source layer with the integral variable k_{ρ}. By comparison, it can be found that the real and imaginary parts of the amplitude coefficients A₀₊ and B₀₋ from the radiation source are larger than those of A₀₋ and B₀₊ from the upper and lower interfaces of the radiation source layer by several orders of magnitude.

FIG. 3 is a distribution of the wave amplitude ratio of the TM wave in the radiation source layer;

FIG. 3 shows the distribution of the wave amplitude ratio

$$\vert \frac{( {A}_{0} {e}^{i {ξ}_{{0}^{z}}} )}{( {B}_{0} {e}^{- i {ξ}_{0} z} )} \vert$$

from above and below at different receiving depth, it can be seen from FIG. 3 that the amplitude ratio varies greatly, especially when the receiving point is located near the plane of the radiation source, the wave amplitude difference of the TM wave is more than 10²⁰⁰ times.

FIGS. 4A-4B show comparisons of the electromagnetic field components obtained by this method and the traditional method under different integral intervals and sampling points. FIG. 4A illustrates the results for different integral intervals with a fixed number of sampling points set to 2²⁰, and FIG. 4B depicts the results for varying numbers of sampling points with the integral interval fixed at [−4,4]. In FIGS. 4A-4B, the electromagnetic field component calculated by the finite element method (FEM) is used as a reference. The curves represent the variation in the intensity of the electromagnetic field component as a function of horizontal distance, calculated using both the proposed method and the traditional method under the specified conditions. It is evident from FIGS. 4A-4B that under the same number of sampling points, the traditional method exhibits significant errors when the integral interval is small, whereas the proposed method maintains a high level of accuracy across all integral intervals. When the integral interval is fixed, the results obtained under different sampling points are similar, demonstrating the stability and reliability of the proposed method in comparison to the traditional method.

FIG. 5 is a comparison of the computing resources required by this method and traditional methods.

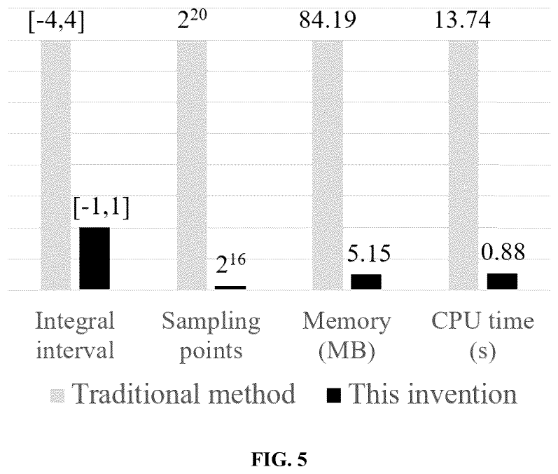

The histogram illustrates a comparison of the computing resources (memory and time) required by the proposed method and the traditional method while ensuring result accuracy. As shown in FIG. 5, under the simulation conditions presented in this application, the proposed method reduces memory usage and computation time by more than 90% compared to the traditional method.

### DETAILED DESCRIPTION OF THE EMBODIMENTS

The invention is further described in combination with the embodiment and the attached figure:

The invention proposes an efficient method for solving the electromagnetic field of the radiation source layer in the layered lossy medium, the technical scheme adopted can be divided into the following four steps:

1. Solving the amplitude coefficients of the electromagnetic wave of the radiation source layer in the lossy medium.

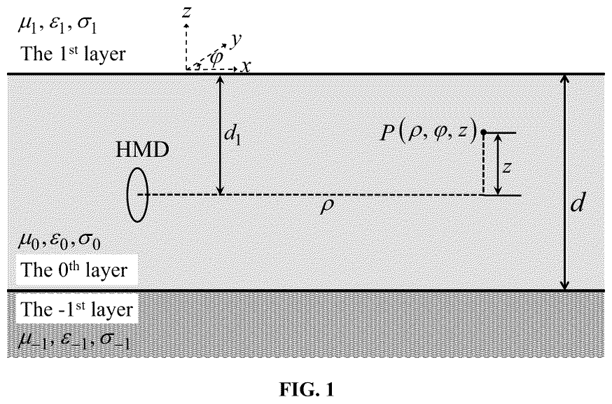

As shown in FIG. 1, it is a three-layer lossy medium model, the electromagnetic field in the radiation source layer can be expressed as the superposition of the TE wave and the TM wave. When the radiation source is a horizontal magnetic dipole (HMD), the expression of each electromagnetic field component in the radiation source layer is:

$${E}_{0 z} = {\int }_{- ∞}^{∞} {dk}_{ρ} ( {A}_{0} {e}^{i {ξ}_{0} z} + {B}_{0} {e}^{- i {ξ}_{0} z} ) {H}_{1}^{( 1 )} ( {k}_{ρ} ρ ) sin ( φ ) \qquad ( 1 )$$

$${E}_{0 ρ} = {\int }_{- ∞}^{∞} {dk}_{ρ} \frac{i {ξ}_{0}}{{k}_{ρ}} ( {A}_{0} {e}^{i {ξ}_{0} z} - {B}_{0} {e}^{- i {ξ}_{0} z} ) {H}_{1}^{{( 1 )}^{′}} ( {k}_{ρ} ρ ) sin ( φ ) + {\int }_{- ∞}^{∞} {dk}_{ρ} \frac{- i ω {μ}_{0}}{{k}_{ρ}^{2} ρ} ( {C}_{0} {e}^{i {ξ}_{0} z} + {D}_{0} {e}^{- i {ξ}_{0} z} ) {H}_{1}^{( 1 )} ( {k}_{ρ} ρ ) sin ( φ )$$

$${E}_{0 φ} = {\int }_{- ∞}^{∞} {dk}_{ρ} \frac{i {ξ}_{0}}{{k}_{ρ}^{2} ρ} ( {A}_{0} {e}^{i {ξ}_{0} z} - {B}_{0} {e}^{- i {ξ}_{0} z} ) {H}_{1}^{( 1 )} ( {k}_{ρ} ρ ) cos ( φ ) + {\int }_{- ∞}^{∞} {dk}_{ρ} \frac{- i ω {μ}_{0}}{{k}_{ρ}} ( {C}_{0} {e}^{i {ξ}_{0} z} + {D}_{0} {e}^{- i {ξ}_{0} z} ) {H}_{1}^{{( 1 )}^{′}} ( {k}_{ρ} ρ ) cos ( φ )$$

$${H}_{0 z} = {\int }_{- ∞}^{∞} {dk}_{ρ} ( {C}_{0} {e}^{i {ξ}_{0} z} + {D}_{0} {e}^{- i {ξ}_{0} z} ) {H}_{1}^{( 1 )} ( {k}_{ρ} ρ ) cos ( φ )$$

$${H}_{0 ρ} = {\int }_{- ∞}^{∞} {dk}_{ρ} \frac{i {ξ}_{0}}{{k}_{ρ}} ( {C}_{0} {e}^{i {ξ}_{0} z} - {D}_{0} {e}^{- i {ξ}_{0} z} ) {H}_{1}^{{( 1 )}^{′}} ( {k}_{ρ} ρ ) cos ( φ ) + {\int }_{- ∞}^{∞} {dk}_{ρ} \frac{- i ω {ε}_{0}^{*}}{{k}_{ρ}^{2} ρ} ( {A}_{0} {e}^{i {ξ}_{0} z} + {B}_{0} {e}^{- i {ξ}_{0} z} ) {H}_{1}^{( 1 )} ( {k}_{ρ} ρ ) cos ( φ )$$

$${H}_{0 φ} = {\int }_{- ∞}^{∞} {dk}_{ρ} \frac{- i {ξ}_{0}}{{k}_{ρ}^{2} ρ} ( {C}_{0} {e}^{i {ξ}_{0} z} - {D}_{0} {e}^{- i {ξ}_{0} z} ) {H}_{1}^{( 1 )} ( {k}_{ρ} ρ ) sin ( φ ) + {\int }_{- ∞}^{∞} {dk}_{ρ} \frac{- i {ωε}_{0}^{*}}{{k}_{ρ}} ( {A}_{0} {e}^{i {ξ}_{0} z} + {B}_{0} {e}^{- i {ξ}_{0} z} ) {H}_{1}^{{( 1 )}^{′}} ( {k}_{ρ} ρ ) sin ( φ )$$

in the formula, A₀, B₀, C₀, and D₀ are amplitude coefficients of TM and TE waves in the radiation source layer, respectively; H₁⁽¹⁾(k_{ρ}ρ) is the first order Hankel function of the first kind; H₁⁽¹⁾′(k_{ρ}ρ) denotes the derivative of H₁⁽¹⁾(η) for argument η; ξ₀ satisfies ξ₀=\sqrt{k₀²−k_{ρ}²}, a propagation constant k₀ in the radiation source layer is expressed as:

$${k}_{0} = \sqrt{i {ωμ}_{0} {σ}_{0} - {ω}^{2} {μ}_{0} {ε}_{0}} .$$

According to the boundary conditions, the propagation matrix, and the dipole antenna type, the amplitude coefficient of the radiation source layer can be obtained when z≥0:

$$\{ \begin{matrix}{A}_{0 +} = \frac{[ {ε}_{0}^{*} {ξ}_{- 1} + {ε}_{- 1}^{*} {ξ}_{0} + ( {ε}_{- 1}^{*} {ξ}_{0} - {ε}_{0}^{*} {ξ}_{- 1} ) {e}^{j 2 {ξ}_{0} {d}_{0}} ] {E}_{hmd}}{{ε}_{0}^{*} {ξ}_{- 1} + {ε}_{- 1}^{*} {ξ}_{0} - \frac{( {ε}_{1}^{*} {ξ}_{0} - {ε}_{0}^{*} {ξ}_{1} ) ( {ε}_{- 1}^{*} {ξ}_{0} - {ε}_{0}^{*} {ξ}_{- 1} )}{{ε}_{1}^{*} {ξ}_{0} + {ε}_{0}^{*} {ξ}_{1}} {e}^{j 2 {ξ}_{0} ( {d}_{1} - {d}_{0} )}} \\ {B}_{0 +} = {A}_{0 +} ( \frac{{ε}_{1}^{*} {ξ}_{0} - {ε}_{0}^{*} {ξ}_{1}}{{ε}_{1}^{*} {ξ}_{0} + {ε}_{0}^{*} {ξ}_{1}} ) {e}^{j 2 {ξ}_{0} {d}_{1}} \\ {C}_{0 +} = \frac{[ {μ}_{0} {ξ}_{- 1} + {μ}_{- 1} {ξ}_{0} - ( {μ}_{- 1} {ξ}_{0} - {μ}_{0} {ξ}_{- 1} ) {e}^{- j 2 {ξ}_{0} {d}_{0}} ] {H}_{hmd}}{{μ}_{0} {ξ}_{- 1} + {μ}_{- 1} {ξ}_{0} - \frac{( {μ}_{1} {ξ}_{0} - {μ}_{0} {ξ}_{1} ) ( {μ}_{- 1} {ξ}_{0} - {μ}_{0} {ξ}_{- 1} )}{{μ}_{1} {ξ}_{0} + {μ}_{0} {ξ}_{1}} {e}^{j 2 {ξ}_{0} ( {d}_{1} - {d}_{0} )}} \\ {D}_{0 +} = {C}_{0 +} ( \frac{{μ}_{1} {ξ}_{0} - {μ}_{0} {ξ}_{1}}{{μ}_{1} {ξ}_{0} + {μ}_{0} {ξ}_{1}} ) {e}^{j 2 {ξ}_{0} {d}_{1}}\end{matrix} \qquad ( 2 )$$

in the formula, A₀₊, B₀₊, C₀₊ and D₀₊ denote amplitude coefficients of the radiation source layer when z≥0. ξₗ=(kₗ²−k_{ρ}²)^{0.5}, kₗ is the propagation constant, εₗ* is the complex dielectric constant and μₗ is the permeability in the l-th layer. E_{hmd}=ISωμ₀k_{ρ}²/8πξ₀, and H_{hmd}=−ISk_{ρ}²/8π. IS is the magnetic dipole moment.

when z≤0, the amplitude coefficient of the radiation source layer is:

$$\{ \begin{matrix}{A}_{0 -} = {A}_{0 +} - {E}_{hmd} \\ {B}_{0 -} = {B}_{0 +} + {E}_{hmd} \\ {C}_{0 -} = {C}_{0 +} - {H}_{hmd} \\ {D}_{0 -} = {D}_{0 +} - {H}_{hmd}\end{matrix} \qquad ( 3 )$$

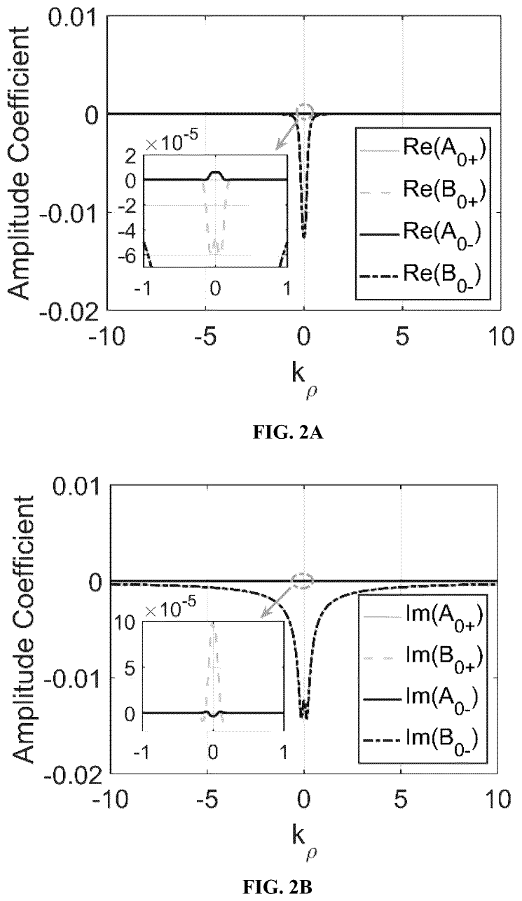

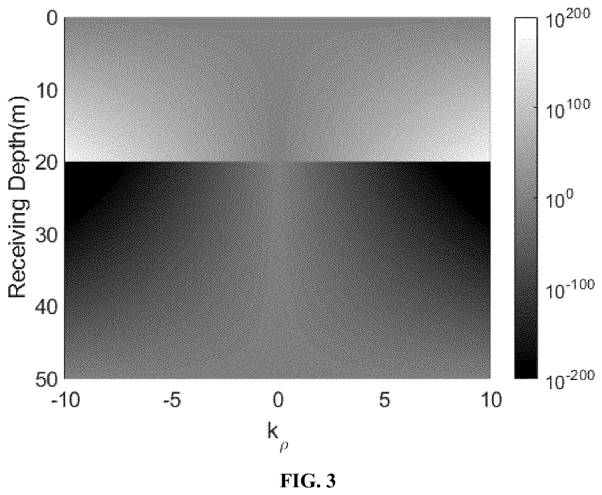

As shown in FIGS. 2A-2B, the amplitude coefficients of TM waves in the radiation source layer exhibit significant variation. Among them, A₀₊ and B₀₋ are the amplitude coefficients from the radiation source, which are several orders of magnitude larger than A₀₋ and B₀₊ from the upper and lower interfaces of the radiation source layer. As shown in FIG. 3, due to the absorption loss in the lossy medium, the ratio of the wave amplitudes from above and below reaches more than 10²⁰⁰ in the vicinity of the plane where the radiation source is located. When using traditional methods to directly substitute A₀₊ and B₀₊ or A₀− and B₀₋ into (1) to accurately solve the electromagnetic field, it is necessary to increase the integration interval and the number of sampling points. This requirement significantly increases computational cost and reduces the efficiency of the solution.

2. Solving the secondary field generated by the upper and lower interfaces of the radiation source layer

To reduce the computational cost and improve algorithm efficiency, this method discards the amplitude coefficient from the radiation source, and instead utilizes A₀₊, B₀₋ and C₀₊, D₀₋ with the smallest amplitude difference to solve the electromagnetic field. These four amplitude coefficients represent the waves originating from the interfaces of the radiation source layer and correspond to the superposition of the lateral wave and the reflected wave. In other words, they characterize the secondary field generated at the interfaces of the radiation source layer. The expression is as follows:

$${E}_{0 z}^{sec} = {\int }_{- ∞}^{∞} {dk}_{ρ} ( {A}_{0 +} {e}^{i {ξ}_{0} z} + {B}_{0 -} {e}^{- i {ξ}_{0} z} ) {H}_{1}^{( 1 )} ( {k}_{ρ} ρ ) sin ( φ ) \qquad ( 4 )$$

$${E}_{0 ρ}^{sec} = {\int }_{- ∞}^{∞} {dk}_{ρ} \frac{i {ξ}_{0}}{{k}_{ρ}} ( {A}_{0 +} {e}^{i {ξ}_{0} z} - {B}_{0 -} {e}^{- i {ξ}_{0} z} ) {H}_{1}^{{( 1 )}^{′}} ( {k}_{ρ} ρ ) sin ( φ ) + {\int }_{- ∞}^{∞} {dk}_{ρ} \frac{- i ω {μ}_{0}}{{k}_{ρ}^{2} ρ} ( {C}_{0 +} {e}^{i {ξ}_{0} z} + {D}_{0 -} {e}^{- i {ξ}_{0} z} ) {H}_{1}^{( 1 )} ( {k}_{ρ} ρ ) sin ( φ )$$

$${E}_{0 φ}^{sec} = {\int }_{- ∞}^{∞} {dk}_{ρ} \frac{i {ξ}_{0}}{{k}_{ρ}^{2} ρ} ( {A}_{0 +} {e}^{i {ξ}_{0} z} - {B}_{0 -} {e}^{- i {ξ}_{0} z} ) {H}_{1}^{( 1 )} ( {k}_{ρ} ρ ) cos ( φ ) + {\int }_{- ∞}^{∞} {dk}_{ρ} \frac{- i ω {μ}_{0}}{{k}_{ρ}} ( {C}_{0 +} {e}^{i {ξ}_{0} z} - {D}_{0 -} {e}^{- i {ξ}_{0} z} ) {H}_{1}^{{( 1 )}^{′}} ( {k}_{ρ} ρ ) cos ( φ )$$

$${H}_{0 z}^{sec} = {\int }_{- ∞}^{∞} {dk}_{ρ} ( {C}_{0 +} {e}^{i {ξ}_{0} z} + {D}_{0 -} {e}^{- i {ξ}_{0} z} ) {H}_{1}^{( 1 )} ( {k}_{ρ} ρ ) cos ( φ )$$

$${H}_{0 ρ}^{sec} = {\int }_{- ∞}^{∞} {dk}_{ρ} \frac{i {ξ}_{0}}{{k}_{ρ}} ( {C}_{0 +} {e}^{i {ξ}_{0} z} - {D}_{0 -} {e}^{- i {ξ}_{0} z} ) {H}_{1}^{{( 1 )}^{′}} ( {k}_{ρ} ρ ) cos ( φ ) + {\int }_{- ∞}^{∞} {dk}_{ρ} \frac{- i ω {ε}_{0}^{*}}{{k}_{ρ}^{2} ρ} ( {A}_{0 +} {e}^{i {ξ}_{0} z} + {B}_{0 -} {e}^{- i {ξ}_{0} z} ) {H}_{1}^{( 1 )} ( {k}_{ρ} ρ ) cos ( φ )$$

$${H}_{0 φ}^{sec} = {\int }_{- ∞}^{∞} {dk}_{ρ} \frac{- i {ξ}_{0}}{{k}_{ρ}^{2} ρ} ( {C}_{0 +} {e}^{i {ξ}_{0} z} - {D}_{0 -} {e}^{- i {ξ}_{0} z} ) {H}_{1}^{( 1 )} ( {k}_{ρ} ρ ) sin ( φ ) + {\int }_{- ∞}^{∞} {dk}_{ρ} \frac{- i {ωε}_{0}^{*}}{{k}_{ρ}} ( {A}_{0 +} {e}^{i {ξ}_{0} z} + {B}_{0 -} {e}^{- i {ξ}_{0} z} ) {H}_{1}^{{( 1 )}^{′}} ( {k}_{ρ} ρ ) sin ( φ )$$

3. Solving the background field generated by the radiation source

Background field refers to the electromagnetic field generated by the radiation source in free space. The electromagnetic field parameters in free space are the same as those in the radiation source layer. The background field can be obtained directly from the theoretical formula, and the expression is as follows:

$${E}_{0 z}^{bac} = \frac{i ω {μ}_{0} ρ IS sin ( φ )}{4 {π ( {ρ}^{2} + {z}^{2} )}^{3 / 2}} ( 1 + {ik}_{0} \sqrt{{ρ}^{2} + {z}^{2}} ) {e}^{- {ik}_{0} \sqrt{{ρ}^{2} + {z}^{2}}} \qquad ( 5 )$$

$${E}_{0 ρ}^{bac} = \frac{i {ωμ}_{0} ρ IS sin ( φ )}{4 {π ( {ρ}^{2} + {z}^{2} )}^{3 / 2}} ( - 1 - {ik}_{0} \sqrt{{ρ}^{2} + {z}^{2}} ) {e}^{- {ik}_{0} \sqrt{{ρ}^{2} + {z}^{2}}}$$

$${E}_{0 φ}^{bac} = \frac{i ω {μ}_{0} zIS cos ( φ )}{4 {π ( {ρ}^{2} + {z}^{2} )}^{3 / 2}} ( - 1 - {ik}_{0} \sqrt{{ρ}^{2} + {z}^{2}} ) {e}^{- {ik}_{0} \sqrt{{ρ}^{2} + {z}^{2}}}$$

$${H}_{0 z}^{bac} = \frac{ISz ρ cos ( φ )}{4 {π ( {ρ}^{2} + {z}^{2} )}^{5 / 2}} ( 3 + i 3 {k}_{0} \sqrt{{ρ}^{2} + {z}^{2}} - {k}_{0}^{2} ( {ρ}^{2} + {z}^{2} ) ) {e}^{- {ik}_{0} \sqrt{{ρ}^{2} + {z}^{2}}}$$

$${H}_{0 ρ}^{bac} = \frac{IS {ρ}^{2} cos ( φ )}{2 {π ( {ρ}^{2} + {z}^{2} )}^{5 / 2}} ( 1 + {ik}_{0} \sqrt{{ρ}^{2} + {z}^{2}} ) {e}^{- {ik}_{0} \sqrt{{ρ}^{2} + {z}^{2}}} - \frac{{ISz}^{2} cos ( φ )}{4 {π ( {ρ}^{2} + {z}^{2} )}^{5 / 2}} ( 1 + {ik}_{0} \sqrt{{ρ}^{2} + {z}^{2}} - {k}_{0}^{2} ( {ρ}^{2} + {z}^{2} ) ) {e}^{- {ik}_{0} \sqrt{{ρ}^{2} + {z}^{2}}}$$

$${H}_{0 φ}^{bac} = \frac{IS sin ( φ )}{4 {π ( {ρ}^{2} + {z}^{2} )}^{5 / 2}} ( 1 + {ik}_{0} \sqrt{{ρ}^{2} + {z}^{2}} - {k}_{0}^{2} ( {ρ}^{2} + {z}^{2} ) ) {e}^{- {ik}_{0} \sqrt{{ρ}^{2} + {z}^{2}}}$$

4. The total field of the received electromagnetic wave is calculated.

Combining the secondary field and the background field in (4) and (5), the components of the total electromagnetic field in the radiation source layer can be obtained as follows:

$${E}_{0 z} = {E}_{0 z}^{sec} + {E}_{0 z}^{b a c} {H}_{0 z} = {H}_{0 z}^{sec} + {H}_{0 z}^{b a c} {E}_{0 ρ} = {E}_{0 ρ}^{sec} + {E}_{0 ρ}^{b a c} {H}_{0 ρ} = {H}_{0 ρ}^{sec} + {H}_{0 ρ}^{b a c} {E}_{0 φ} = {E}_{0 φ}^{sec} + {E}_{0 φ}^{b a c} {H}_{0 φ} = {H}_{0 φ}^{sec} + {H}_{0 φ}^{bac} \qquad ( 6 )$$

Except for the background field, the proposed method does not require additional calculations and space compared to traditional methods. This method significantly reduces both the integration interval requirements and the number of sampling points needed during the solution process. This optimization leads to a substantial reduction in overall computational costs and enhanced algorithmic efficiency.

### Verification:

Taking the three-layer lossy medium model with a horizontal magnetic dipole antenna as the radiation source as an example, an embodiment of the invention is given. To validate the accuracy and computational efficiency of the proposed method, comprehensive numerical simulations were conducted in this application.

The simulation conditions are as follows:

the radiation source is located in the 0^{th} layer at a distance of 20 m from the upper interface, with a magnetic dipole moment of 10 A·m². The receiving point is situated 10 m above the radiation source, and the operating frequency is set at 10 kHz. The electromagnetic parameters in each layer are shown in Table 1. The positions of the radiation source and the receiving point under the simulation conditions apply to the constraints of the invention.

TABLE 1
Electromagnetic parameters in each layer of medium

| | 1^{ST} LAYER | 0^{TH} LAYER | −1^{ST} LAYER |
|---|---|---|---|
| Relative dielectric | 1 | 81 | 8 |
| constant | | | |
| Permeability (H/m) | 4π × 10⁻⁷ | 4π × 10⁻⁷ | 4π × 10⁻⁷ |
| Conductivity(S/m) | 0.01 | 4 | 0.1 |
| Thickness (m) | Inf | 50 | Inf |

### All in all:

1. The solving method exhibits both simplicity and clarity.

In the solving method proposed in this application, the background field can be obtained by theoretical formula, and the secondary field can be solved by directly selecting the amplitude coefficients from the upper and lower interfaces in the radiation source layer. This reduces the amplitude coefficient difference used to solve the electromagnetic field in the radiation source layer, the whole process is simple and the physical meaning is clear.

2. Feasibility of the solving method

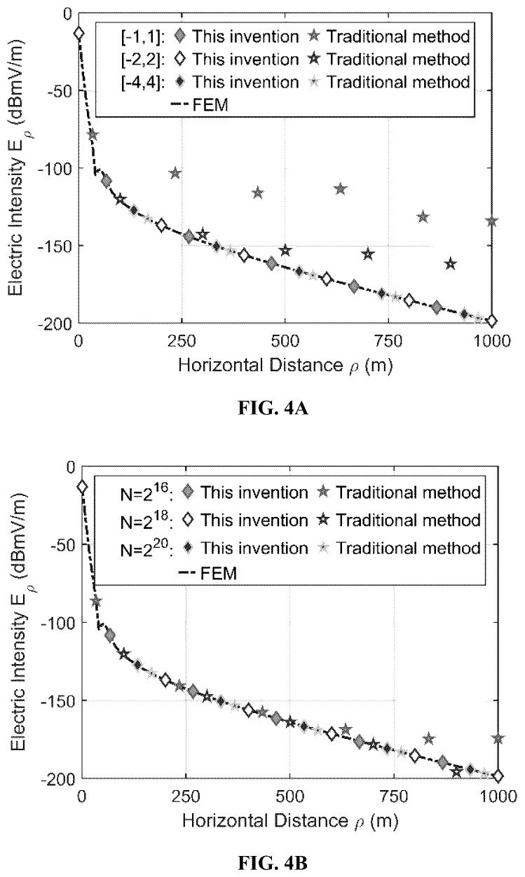

As shown in FIGS. 4A-4B, the traditional method achieves consistency between the electromagnetic fields obtained and those derived using the finite element method only when higher integration ranges and a larger number of sampling points are employed. In contrast, the proposed solution method yields accurate results under all conditions. This demonstrates the feasibility and robustness of the proposed method.

3. Efficiency of the solving method

As illustrated in FIG. 5, under the premise of ensuring the accuracy of the results, the proposed method outperforms the traditional method in terms of the required computational space and time. This indicates that the proposed method demands fewer computing resources and exhibits higher computational efficiency.

4. According to the embodiment, it is considered that:

An efficient method for solving the electromagnetic field of the radiation source layer in a layered lossy medium proposed by the invention is feasible. While this method introduces an additional step of computing the background field compared to the traditional method, it maintains the accuracy of the computational results while significantly reducing computational resource demands and improving computational efficiency. Moreover, the selection of amplitude coefficients for the electromagnetic field calculation is consistent with the principles governing secondary field generation. The overall methodology is straightforward and possesses clear physical interpretability.

What is claimed is:

1. An efficient method for solving an electromagnetic field of a radiation source layer in a layered lossy medium, comprising the following steps:
step 1: expressing an electromagnetic field of a radiation source layer in a layered lossy medium model as a superposition of Transverse Electric (TE) and Transverse Magnetic (TM) waves, and establishing an electromagnetic field expression of each electromagnetic field component;
step 2: according to boundary conditions of the electromagnetic field, a propagation matrix, and a dipole antenna type, obtaining amplitude coefficients of the radiation source layer when z≥0:
$$\{ \begin{matrix}{A}_{0 +} = \frac{[ {ε}_{0}^{*} {ξ}_{- 1} + {ε}_{- 1}^{*} {ξ}_{0} + ( {ε}_{- 1}^{*} {ξ}_{0} - {ε}_{0}^{*} {ξ}_{- 1} ) {e}^{- j 2 {ξ}_{0} {d}_{0}} ] {E}_{h m d}}{{ε}_{0}^{*} {ξ}_{- 1} + {ε}_{- 1}^{*} {ξ}_{0} - \frac{( {ε}_{1}^{*} {ξ}_{0} - {ε}_{0}^{*} {ξ}_{1} ) ( {ε}_{- 1}^{*} {ξ}_{0} - {ε}_{0}^{*} {ξ}_{- 1} )}{{ε}_{1}^{*} {ξ}_{0} + {ε}_{0}^{*} {ξ}_{1}} {e}^{j 2 {ξ}_{0} ( {d}_{1} - {d}_{0} )}} \\ {B}_{0 +} = {A}_{0 +} ( \frac{{ε}_{1}^{*} {ξ}_{0} - {ε}_{0}^{*} {ξ}_{1}}{{ε}_{1}^{*} {ξ}_{0} + {ε}_{0}^{*} {ξ}_{1}} ) {e}^{j 2 {ξ}_{0} {d}_{1}} \\ {C}_{0 +} = \frac{[ {μ}_{0} {ξ}_{- 1} + {μ}_{- 1} {ξ}_{0} - ( {μ}_{- 1} {ξ}_{0} - {μ}_{0} {ξ}_{- 1} ) {e}^{- j 2 {ξ}_{0} {d}_{0}} ] {H}_{h m d}}{{μ}_{0} {ξ}_{- 1} + {μ}_{- 1} {ξ}_{0} - \frac{( {μ}_{1} {ξ}_{0} - {μ}_{0} {ξ}_{1} ) ( {μ}_{- 1} {ξ}_{0} - {μ}_{0} {ξ}_{- 1} )}{{μ}_{1} {ξ}_{0} + {μ}_{0} {ξ}_{1}} {e}^{j 2 {ξ}_{0} ( {d}_{1} - {d}_{0} )}} \\ {D}_{0 +} = {C}_{0 +} ( \frac{{μ}_{1} {ξ}_{0} - {μ}_{0} {ξ}_{1}}{{μ}_{1} {ξ}_{0} + {μ}_{0} {ξ}_{1}} ) {e}^{j 2 {ξ}_{0} {d}_{1}}\end{matrix}$$
wherein A₀₊, B₀₊, C₀₊ and D₀₊ denote the amplitude coefficients of the radiation source layer when z≥0; ξₗ=(kₗ²−k_{ρ}²)^{0.5}, kₗ is a propagation constant, εₗ* is a complex dielectric constant, and μₗ is a permeability in an l-th layer; E_{hmd}=ISωμ₀k_{ρ}²/8πξ₀ and H_{hmd}=−ISk_{ρ}²/8π, and IS is a magnetic dipole moment;
the amplitude coefficients of the radiation source layer when z≤0:
$$\{ \begin{matrix}{A}_{0 -} = {A}_{0 +} - {E}_{h m d} \\ {B}_{0 -} = {B}_{0 +} + {E}_{h m d} \\ {C}_{0 -} = {C}_{0 +} - {H}_{h m d} \\ {D}_{0 -} = {D}_{0 +} - {H}_{h m d}\end{matrix}$$
step 3: selecting A₀₊, B₀₋, C₀₊, and D₀₋ with smallest amplitude differences and substituting A₀₊, B₀₋, C₀₊, and D₀₋ with the smallest amplitude differences into the electromagnetic field expression to solve each electromagnetic field component, and obtaining a secondary field composed of lateral waves and reflected waves from upper and lower interfaces of the radiation source layer; and
step 4: performing a vector sum of the secondary field and a background field to obtain each component of a total electromagnetic field in the radiation source layer.

2. The efficient method according to claim 1, wherein a three-layer lossy medium model is taken as an example, and a thickness of a 1^{st} layer to a −1^{st} layer is infinite; a 0^{th} layer is a layer where a radiation source is located, a thickness of the 0^{th} layer is d, a radiation antenna is a horizontal magnetic dipole (HMD), and a distance from the radiation antenna to an upper interface of the 0^{th} layer is dₗ; an origin O of a cylindrical coordinate system is at a center of the radiation source; a receiving point P is located in a coordinate (ρ, φ, z); and μₗ, εₗ, and σₗ are the permeability, a dielectric constant and a conductivity of the l-th layer (l=−1, 0, 1), respectively.

3. The efficient method according to claim 1, wherein in step 1, when a solved radiation source is an HMD, expressions of each electromagnetic field component in the radiation source layer are:
$${E}_{0 z} = {\int }_{- ∞}^{∞} d {k}_{ρ} ( {A}_{0} {e}^{i {ξ}_{0} z} + {B}_{0} {e}^{- i {ξ}_{0} z} ) {H}_{1}^{( 1 )} ( {k}_{ρ} ρ ) sin ( φ ) \\ {E}_{0 ρ} = {\int }_{- ∞}^{∞} d {k}_{ρ} \frac{i {ξ}_{0}}{{k}_{ρ}} ( {A}_{0} {e}^{i {ξ}_{0} z} - {B}_{0} {e}^{- i {ξ}_{0} z} ) {H}_{1}^{{( 1 )}^{′}} ( {k}_{ρ} ρ ) sin ( φ ) + {\int }_{- ∞}^{∞} d {k}_{ρ} \frac{- i ω {μ}_{0}}{{k}_{ρ}^{2} ρ} ( {C}_{0} {e}^{i {ξ}_{0} z} + {D}_{0} {e}^{- i {ξ}_{0} z} ) {H}_{1}^{( 1 )} ( {k}_{ρ} ρ ) sin ( φ ) \\ {E}_{0 φ} = {\int }_{- ∞}^{∞} d {k}_{ρ} \frac{i {ξ}_{0}}{{k}_{ρ}^{2} ρ} ( {A}_{0} {e}^{i {ξ}_{0} z} - {B}_{0} {e}^{- i {ξ}_{0} z} ) {H}_{1}^{( 1 )} ( {k}_{ρ} ρ ) cos ( φ ) + {\int }_{- ∞}^{∞} {dk}_{ρ} \frac{- i ω {μ}_{0}}{{k}_{ρ}} ( {C}_{0} {e}^{i {ξ}_{0} z} + {D}_{0} {e}^{- i {ξ}_{0} z} ) {H}_{1}^{{( 1 )}^{′}} ( {k}_{ρ} ρ ) cos ( φ ) \\ {H}_{0 z} = {\int }_{- ∞}^{∞} {dk}_{ρ} ( {C}_{0} {e}^{i {ξ}_{0} z} + {D}_{0} {e}^{- i {ξ}_{0} z} ) {H}_{1}^{( 1 )} ( {k}_{ρ} ρ ) cos ( φ ) \\ {H}_{0 ρ} = {\int }_{- ∞}^{∞} {dk}_{ρ} \frac{i {ξ}_{0}}{{k}_{ρ}} ( {C}_{0} {e}^{i {ξ}_{0} z} - {D}_{0} {e}^{- i {ξ}_{0} z} ) {H}_{1}^{{( 1 )}^{′}} ( {k}_{ρ} ρ ) cos ( φ ) + {\int }_{- ∞}^{∞} {dk}_{ρ} \frac{- i ω {ε}_{0}^{*}}{{k}_{ρ}^{2} ρ} ( {A}_{0} {e}^{i {ξ}_{0} z} + {B}_{0} {e}^{- i {ξ}_{0} z} ) {H}_{1}^{( 1 )} ( {k}_{ρ} ρ ) cos ( φ ) \\ {H}_{0 φ} = {\int }_{- ∞}^{∞} {dk}_{ρ} \frac{- i {ξ}_{0}}{{k}_{ρ}^{2} ρ} ( {C}_{0} {e}^{i {ξ}_{0} z} - {D}_{0} {e}^{- i {ξ}_{0} z} ) {H}_{1}^{( 1 )} ( {k}_{ρ} ρ ) sin ( φ ) + {\int }_{- ∞}^{∞} {dk}_{ρ} \frac{i ω {ε}_{0}^{*}}{{k}_{ρ}} ( {A}_{0} {e}^{i {ξ}_{0} z} + {B}_{0} {e}^{- i {ξ}_{0} z} ) {H}_{1}^{{( 1 )}^{′}} ( {k}_{ρ} ρ ) sin ( φ ) ,$$
wherein A₀, B₀, C₀, and D₀ are amplitude coefficients of the TM and TE waves in the radiation source layer, respectively; H₁⁽¹⁾(k_{ρ}ρ) is a first order Hankel function of a first kind; H₁⁽¹⁾′(k_{ρ}ρ) denotes a derivative of H₁⁽¹⁾(η) for argument η; ξ₀ satisfies ξ₀=\sqrt{k₀²−k_{ρ}²}, and a propagation constant k₀ in the radiation source layer is expressed as:
$${k}_{0} = \sqrt{i {ωμ}_{0} {σ}_{0} - {ω}^{2} {μ}_{0} {ε}_{0}} .$$

4. The efficient method according to claim 1, wherein the secondary field in step 3 is:
$${E}_{0 z}^{sec} = {\int }_{- ∞}^{∞} d {k}_{ρ} ( {A}_{0 +} {e}^{i {ξ}_{0} z} + {B}_{0 -} {e}^{- i {ξ}_{0} z} ) {H}_{1}^{( 1 )} ( {k}_{ρ} ρ ) sin ( φ ) \\ {E}_{0 ρ}^{sec} = {\int }_{- ∞}^{∞} d {k}_{ρ} \frac{i {ξ}_{0}}{{k}_{ρ}} ( {A}_{0 +} {e}^{i {ξ}_{0} z} - {B}_{0 -} {e}^{- i {ξ}_{0} z} ) {H}_{1}^{{( 1 )}^{′}} ( {k}_{ρ} ρ ) sin ( φ ) + {\int }_{- ∞}^{∞} d {k}_{ρ} \frac{- i {ωμ}_{0}}{{k}_{ρ}^{2} ρ} ( {C}_{0 +} {e}^{i {ξ}_{0} z} + {D}_{0 -} {e}^{- i {ξ}_{0} z} ) {H}_{1}^{( 1 )} ( {k}_{ρ} ρ ) sin ( φ ) \\ {E}_{0 φ}^{sec} = {\int }_{- ∞}^{∞} d {k}_{ρ} \frac{i {ξ}_{0}}{{k}_{ρ}^{2} ρ} ( {A}_{0 +} {e}^{i {ξ}_{0} z} - {B}_{0 -} {e}^{- i {ξ}_{0} z} ) {H}_{1}^{( 1 )} ( {k}_{ρ} ρ ) cos ( φ ) + {\int }_{- ∞}^{∞} d {k}_{ρ} \frac{- i {ωμ}_{0}}{{k}_{ρ}} ( {C}_{0 +} {e}^{i {ξ}_{0} z} - {D}_{0 -} {e}^{- i {ξ}_{0} z} ) {H}_{1}^{{( 1 )}^{′}} ( {k}_{ρ} ρ ) cos ( φ ) \\ {H}_{0 z}^{sec} = {\int }_{- ∞}^{∞} d {k}_{ρ} ( {C}_{0 +} {e}^{i {ξ}_{0} z} + {D}_{0 -} {e}^{- i {ξ}_{0} z} ) {H}_{1}^{( 1 )} ( {k}_{ρ} ρ ) cos ( φ ) \\ {H}_{0 ρ}^{sec} = {\int }_{- ∞}^{∞} d {k}_{ρ} \frac{i {ξ}_{0}}{{k}_{ρ}} ( {C}_{0 +} {e}^{i {ξ}_{0} z} - {D}_{0 -} {e}^{- i {ξ}_{0} z} ) {H}_{1}^{{( 1 )}^{′}} ( {k}_{ρ} ρ ) cos ( φ ) + {\int }_{- ∞}^{∞} d {k}_{ρ} \frac{- i {ωε}_{0}^{*}}{{k}_{ρ}^{2} ρ} ( {A}_{0 +} {e}^{i {ξ}_{0} z} + {B}_{0 -} {e}^{- i {ξ}_{0} z} ) {H}_{1}^{( 1 )} ( {k}_{ρ} ρ ) cos ( φ ) \\ {H}_{0 φ}^{sec} = {\int }_{- ∞}^{∞} d {k}_{ρ} \frac{- i {ξ}_{0}}{{k}_{ρ}^{2} ρ} ( {C}_{0 +} {e}^{i {ξ}_{0} z} - {D}_{0 -} {e}^{- i {ξ}_{0} z} ) {H}_{1}^{( 1 )} ( {k}_{ρ} ρ ) sin ( φ ) + {\int }_{- ∞}^{∞} d {k}_{ρ} \frac{i {ωε}_{0}^{*}}{{k}_{ρ}} ( {A}_{0 +} {e}^{i {ξ}_{0} z} + {B}_{0 -} {e}^{- i {ξ}_{0} z} ) {H}_{1}^{{( 1 )}^{′}} ( {k}_{ρ} ρ ) sin ( φ ) .$$

5. The efficient method according to claim 1, wherein each component of the total electromagnetic field in step 4 is:
$${E}_{0 z} = {E}_{0 z}^{sec} + {E}_{0 z}^{b a c} {H}_{0 z} = {H}_{0 z}^{sec} + {H}_{0 z}^{b a c} {E}_{0 ρ} = {E}_{0 ρ}^{sec} + {E}_{0 ρ}^{b a c} {H}_{0 ρ} = {H}_{0 ρ}^{sec} + {H}_{0 ρ}^{b a c} {E}_{0 φ} = {E}_{0 φ}^{sec} + {E}_{0 φ}^{b a c} {H}_{0 φ} = {H}_{0 φ}^{sec} + {H}_{0 φ}^{b a c} .$$

6. The efficient method according to claim 1, wherein the background field is obtained directly from a theoretical formula:
$${E}_{0 z}^{b a c} = \frac{i ω {μ}_{0} ρ IS sin ( φ )}{4 {π ( {ρ}^{2} + {z}^{2} )}^{3 / 2}} ( 1 + i {k}_{0} \sqrt{{ρ}^{2} + {z}^{2}} ) {e}^{- i {k}_{0}} \sqrt{{ρ}^{2} + {z}^{2}} \\ {E}_{0 ρ}^{b a c} = \frac{i ω {μ}_{0} zIS sin ( φ )}{4 {π ( {ρ}^{2} + {z}^{2} )}^{3 / 2}} ( - 1 - i {k}_{0} \sqrt{{ρ}^{2} + {z}^{2}} ) {e}^{- i {k}_{0}} \sqrt{{ρ}^{2} + {z}^{2}} \\ {E}_{0 φ}^{b a c} = \frac{i ω {μ}_{0} zIS cos ( φ )}{4 {π ( {ρ}^{2} + {z}^{2} )}^{3 / 2}} ( - 1 - i {k}_{0} \sqrt{{ρ}^{2} + {z}^{2}} ) {e}^{- i {k}_{0}} \sqrt{{ρ}^{2} + {z}^{2}} \\ {H}_{0 z}^{b a c} = \frac{ISz ρ cos ( φ )}{4 {π ( {ρ}^{2} + {z}^{2} )}^{5 / 2}} ( 3 + i 3 {k}_{0} \sqrt{{ρ}^{2} + {z}^{2}} - {k}_{0}^{2} ( {ρ}^{2} + {z}^{2} ) ) {e}^{- i {k}_{0}} \sqrt{{ρ}^{2} + {z}^{2}} \\ {H}_{0 ρ}^{b a c} = \frac{I S {ρ}^{2} cos ( φ )}{2 {π ( {ρ}^{2} + {z}^{2} )}^{5 / 2}} ( 1 + i {k}_{0} \sqrt{{ρ}^{2} + {z}^{2}} ) {e}^{- i {k}_{0}} \sqrt{{ρ}^{2} + {z}^{2}} - \frac{I S {z}^{2} cos ( φ )}{4 {π ( {ρ}^{2} + {z}^{2} )}^{5 / 2}} ( 1 + i {k}_{0} \sqrt{{ρ}^{2} + {z}^{2}} - {k}_{0}^{2} ( {ρ}^{2} + {z}^{2} ) ) {e}^{- i {k}_{0}} \sqrt{{ρ}^{2} + {z}^{2}} \\ {H}_{0 φ}^{b a c} = \frac{IS sin ( φ )}{4 {π ( {ρ}^{2} + {z}^{2} )}^{5 / 2}} ( 1 + i {k}_{0} \sqrt{{ρ}^{2} + {z}^{2}} - {k}_{0}^{2} ( {ρ}^{2} + {z}^{2} ) ) {e}^{- i {k}_{0}} \sqrt{{ρ}^{2} + {z}^{2}} .$$

7. An application method of the efficient method according to claim 1, comprising: selecting the amplitude coefficients with the smallest amplitude differences to obtain the secondary field of the radiation source layer, and then obtaining the total electromagnetic field of the radiation source layer through vector superposition with the background field, to support an efficient development of marine electromagnetic detection research.

8. The application method according to claim 7, wherein in the efficient method, a three-layer lossy medium model is taken as an example, and a thickness of a 1^{st} layer to a −1^{st} layer is infinite; a 0^{th} layer is a layer where a radiation source is located, a thickness of the 0^{th} layer is d, a radiation antenna is a horizontal magnetic dipole (HMD), and a distance from the radiation antenna to an upper interface of the 0^{th} layer is dₗ; an origin O of a cylindrical coordinate system is at a center of the radiation source; a receiving point P is located in a coordinate (ρ, φ, z); and μₗ, εₗ, and σₗ are the permeability, a dielectric constant and a conductivity of the l-th layer (l=−1, 0, 1), respectively.

9. The application method according to claim 7, wherein in step 1 of the efficient method, when a solved radiation source is an HMD, expressions of each electromagnetic field component in the radiation source layer are:
$${E}_{0 z} = {\int }_{- ∞}^{∞} d {k}_{ρ} ( {A}_{0} {e}^{i {ξ}_{0} z} + {B}_{0} {e}^{- i {ξ}_{0} z} ) {H}_{1}^{( 1 )} ( {k}_{ρ} ρ ) sin ( φ ) \\ {E}_{0 ρ} = {\int }_{- ∞}^{∞} d {k}_{ρ} \frac{i {ξ}_{0}}{{k}_{ρ}} ( {A}_{0} {e}^{i {ξ}_{0} z} - {B}_{0} {e}^{- i {ξ}_{0} z} ) {H}_{1}^{{( 1 )}^{′}} ( {k}_{ρ} ρ ) sin ( φ ) + {\int }_{- ∞}^{∞} d {k}_{ρ} \frac{- i ω {μ}_{0}}{{k}_{ρ}^{2} ρ} ( {C}_{0} {e}^{i {ξ}_{0} z} + {D}_{0} {e}^{- i {ξ}_{0} z} ) {H}_{1}^{( 1 )} ( {k}_{ρ} ρ ) sin ( φ ) \\ {E}_{0 φ} = {\int }_{- ∞}^{∞} d {k}_{ρ} \frac{i {ξ}_{0}}{{k}_{ρ}^{2} ρ} ( {A}_{0} {e}^{i {ξ}_{0} z} - {B}_{0} {e}^{- i {ξ}_{0} z} ) {H}_{1}^{( 1 )} ( {k}_{ρ} ρ ) cos ( φ ) + {\int }_{- ∞}^{∞} {dk}_{ρ} \frac{- i ω {μ}_{0}}{{k}_{ρ}} ( {C}_{0} {e}^{i {ξ}_{0} z} + {D}_{0} {e}^{- i {ξ}_{0} z} ) {H}_{1}^{{( 1 )}^{′}} ( {k}_{ρ} ρ ) cos ( φ ) \\ {H}_{0 z} = {\int }_{- ∞}^{∞} {dk}_{ρ} ( {C}_{0} {e}^{i {ξ}_{0} z} + {D}_{0} {e}^{- i {ξ}_{0} z} ) {H}_{1}^{( 1 )} ( {k}_{ρ} ρ ) cos ( φ ) \\ {H}_{0 ρ} = {\int }_{- ∞}^{∞} {dk}_{ρ} \frac{i {ξ}_{0}}{{k}_{ρ}} ( {C}_{0} {e}^{i {ξ}_{0} z} - {D}_{0} {e}^{- i {ξ}_{0} z} ) {H}_{1}^{{( 1 )}^{′}} ( {k}_{ρ} ρ ) cos ( φ ) + {\int }_{- ∞}^{∞} {dk}_{ρ} \frac{- i ω {ε}_{0}^{*}}{{k}_{ρ}^{2} ρ} ( {A}_{0} {e}^{i {ξ}_{0} z} + {B}_{0} {e}^{- i {ξ}_{0} z} ) {H}_{1}^{( 1 )} ( {k}_{ρ} ρ ) cos ( φ ) \\ {H}_{0 φ} = {\int }_{- ∞}^{∞} {dk}_{ρ} \frac{- i {ξ}_{0}}{{k}_{ρ}^{2} ρ} ( {C}_{0} {e}^{i {ξ}_{0} z} - {D}_{0} {e}^{- i {ξ}_{0} z} ) {H}_{1}^{( 1 )} ( {k}_{ρ} ρ ) sin ( φ ) + {\int }_{- ∞}^{∞} {dk}_{ρ} \frac{i ω {ε}_{0}^{*}}{{k}_{ρ}} ( {A}_{0} {e}^{i {ξ}_{0} z} + {B}_{0} {e}^{- i {ξ}_{0} z} ) {H}_{1}^{{( 1 )}^{′}} ( {k}_{ρ} ρ ) sin ( φ ) ,$$
wherein A₀, B₀, C₀, and Do are amplitude coefficients of the TM and TE waves in the radiation source layer, respectively; H₁⁽¹⁾(k_{ρ}ρ) is a first order Hankel function of a first kind; H₁⁽¹⁾′(k_{ρ}ρ) denotes a derivative of H₁⁽¹⁾(η) for argument η; ξ₀ satisfies ξ₀=\sqrt{k₀²−k_{ρ}²}, and a propagation constant k₀ in the radiation source layer is expressed as:
$${k}_{0} = \sqrt{i {ωμ}_{0} {σ}_{0} - {ω}^{2} {μ}_{0} {ε}_{0}} .$$

10. The application method according to claim 7, wherein the secondary field in step 3 of the efficient method is:
$${E}_{0 z}^{sec} = {\int }_{- ∞}^{∞} d {k}_{ρ} ( {A}_{0 +} {e}^{i {ξ}_{0} z} + {B}_{0 -} {e}^{- i {ξ}_{0} z} ) {H}_{1}^{( 1 )} ( {k}_{ρ} ρ ) sin ( φ ) \\ {E}_{0 ρ}^{sec} = {\int }_{- ∞}^{∞} d {k}_{ρ} \frac{i {ξ}_{0}}{{k}_{ρ}} ( {A}_{0 +} {e}^{i {ξ}_{0} z} - {B}_{0 -} {e}^{- i {ξ}_{0} z} ) {H}_{1}^{{( 1 )}^{′}} ( {k}_{ρ} ρ ) sin ( φ ) + {\int }_{- ∞}^{∞} d {k}_{ρ} \frac{- i {ωμ}_{0}}{{k}_{ρ}^{2} ρ} ( {C}_{0 +} {e}^{i {ξ}_{0} z} + {D}_{0 -} {e}^{- i {ξ}_{0} z} ) {H}_{1}^{( 1 )} ( {k}_{ρ} ρ ) sin ( φ ) \\ {E}_{0 φ}^{sec} = {\int }_{- ∞}^{∞} d {k}_{ρ} \frac{i {ξ}_{0}}{{k}_{ρ}^{2} ρ} ( {A}_{0 +} {e}^{i {ξ}_{0} z} - {B}_{0 -} {e}^{- i {ξ}_{0} z} ) {H}_{1}^{( 1 )} ( {k}_{ρ} ρ ) cos ( φ ) + {\int }_{- ∞}^{∞} d {k}_{ρ} \frac{- i {ωμ}_{0}}{{k}_{ρ}} ( {C}_{0 +} {e}^{i {ξ}_{0} z} - {D}_{0 -} {e}^{- i {ξ}_{0} z} ) {H}_{1}^{{( 1 )}^{′}} ( {k}_{ρ} ρ ) cos ( φ ) \\ {H}_{0 z}^{sec} = {\int }_{- ∞}^{∞} d {k}_{ρ} ( {C}_{0 +} {e}^{i {ξ}_{0} z} + {D}_{0 -} {e}^{- i {ξ}_{0} z} ) {H}_{1}^{( 1 )} ( {k}_{ρ} ρ ) cos ( φ ) \\ {H}_{0 ρ}^{sec} = {\int }_{- ∞}^{∞} d {k}_{ρ} \frac{i {ξ}_{0}}{{k}_{ρ}} ( {C}_{0 +} {e}^{i {ξ}_{0} z} - {D}_{0 -} {e}^{- i {ξ}_{0} z} ) {H}_{1}^{{( 1 )}^{′}} ( {k}_{ρ} ρ ) cos ( φ ) + {\int }_{- ∞}^{∞} d {k}_{ρ} \frac{- i {ωε}_{0}^{*}}{{k}_{ρ}^{2} ρ} ( {A}_{0 +} {e}^{i {ξ}_{0} z} + {B}_{0 -} {e}^{- i {ξ}_{0} z} ) {H}_{1}^{( 1 )} ( {k}_{ρ} ρ ) cos ( φ ) \\ {H}_{0 φ}^{sec} = {\int }_{- ∞}^{∞} d {k}_{ρ} \frac{- i {ξ}_{0}}{{k}_{ρ}^{2} ρ} ( {C}_{0 +} {e}^{i {ξ}_{0} z} - {D}_{0 -} {e}^{- i {ξ}_{0} z} ) {H}_{1}^{( 1 )} ( {k}_{ρ} ρ ) sin ( φ ) + {\int }_{- ∞}^{∞} d {k}_{ρ} \frac{i {ωε}_{0}^{*}}{{k}_{ρ}} ( {A}_{0 +} {e}^{i {ξ}_{0} z} + {B}_{0 -} {e}^{- i {ξ}_{0} z} ) {H}_{1}^{{( 1 )}^{′}} ( {k}_{ρ} ρ ) sin ( φ ) .$$

11. The application method according to claim 7, wherein each component of the total electromagnetic field in step 4 of the efficient method is:
$${E}_{0 z} = {E}_{0 z}^{sec} + {E}_{0 z}^{b a c} {H}_{0 z} = {H}_{0 z}^{sec} + {H}_{0 z}^{b a c} {E}_{0 ρ} = {E}_{0 ρ}^{sec} + {E}_{0 ρ}^{b a c} {H}_{0 ρ} = {H}_{0 ρ}^{sec} + {H}_{0 ρ}^{b a c} {E}_{0 φ} = {E}_{0 φ}^{sec} + {E}_{0 φ}^{b a c} {H}_{0 φ} = {H}_{0 φ}^{sec} + {H}_{0 φ}^{b a c} .$$

12. The application method according to claim 7, wherein in the efficient method, the background field is obtained directly from a theoretical formula:
$${E}_{0 z}^{b a c} = \frac{i ω {μ}_{0} ρ IS sin ( φ )}{4 {π ( {ρ}^{2} + {z}^{2} )}^{3 / 2}} ( 1 + i {k}_{0} \sqrt{{ρ}^{2} + {z}^{2}} ) {e}^{- i {k}_{0}} \sqrt{{ρ}^{2} + {z}^{2}} \\ {E}_{0 ρ}^{b a c} = \frac{i ω {μ}_{0} zIS sin ( φ )}{4 {π ( {ρ}^{2} + {z}^{2} )}^{3 / 2}} ( - 1 - i {k}_{0} \sqrt{{ρ}^{2} + {z}^{2}} ) {e}^{- i {k}_{0}} \sqrt{{ρ}^{2} + {z}^{2}} \\ {E}_{0 φ}^{b a c} = \frac{i ω {μ}_{0} zIS cos ( φ )}{4 {π ( {ρ}^{2} + {z}^{2} )}^{3 / 2}} ( - 1 - i {k}_{0} \sqrt{{ρ}^{2} + {z}^{2}} ) {e}^{- i {k}_{0}} \sqrt{{ρ}^{2} + {z}^{2}} \\ {H}_{0 z}^{b a c} = \frac{ISz ρ cos ( φ )}{4 {π ( {ρ}^{2} + {z}^{2} )}^{5 / 2}} ( 3 + i 3 {k}_{0} \sqrt{{ρ}^{2} + {z}^{2}} - {k}_{0}^{2} ( {ρ}^{2} + {z}^{2} ) ) {e}^{- i {k}_{0}} \sqrt{{ρ}^{2} + {z}^{2}} \\ {H}_{0 ρ}^{b a c} = \frac{I S {ρ}^{2} cos ( φ )}{2 {π ( {ρ}^{2} + {z}^{2} )}^{5 / 2}} ( 1 + i {k}_{0} \sqrt{{ρ}^{2} + {z}^{2}} ) {e}^{- i {k}_{0}} \sqrt{{ρ}^{2} + {z}^{2}} - \frac{I S {z}^{2} cos ( φ )}{4 {π ( {ρ}^{2} + {z}^{2} )}^{5 / 2}} ( 1 + i {k}_{0} \sqrt{{ρ}^{2} + {z}^{2}} - {k}_{0}^{2} ( {ρ}^{2} + {z}^{2} ) ) {e}^{- i {k}_{0}} \sqrt{{ρ}^{2} + {z}^{2}} \\ {H}_{0 φ}^{b a c} = \frac{IS sin ( φ )}{4 {π ( {ρ}^{2} + {z}^{2} )}^{5 / 2}} ( 1 + i {k}_{0} \sqrt{{ρ}^{2} + {z}^{2}} - {k}_{0}^{2} ( {ρ}^{2} + {z}^{2} ) ) {e}^{- i {k}_{0}} \sqrt{{ρ}^{2} + {z}^{2}} .$$
